(19) United States
(12) Patent Application Publication
(10) Pub. No.: US 2010/0320211 A1
(43) Pub. Date: Dec. 23, 2010

(54) WASTE BIN TO COLLECT LITTER AND RECYCLABLES AND ASSOCIATED RECYCLING METHOD

(75) Inventor: Steve Holland, Batavia, IL (US)

Correspondence Address: MCANDREWS HELD & MALLOY, LTD, 500 WEST MADISON STREET, SUITE 3400, CHICAGO, IL, 60661, US

(73) Assignee: FREE GREEN CAN, LLC, Aurora, IL (US)

(21) Appl. No.: 12/487,375

(22) Filed: Jun. 18, 2009

(51) Int. Cl. B65D 25/14; G06Q 90/00; B65D 51/04

(52) U.S. Cl. 220/495.06; 705/500; 220/810

(57) ABSTRACT

A waste bin to collect litter and recyclables is disclosed. The waste bin includes a waste bin body, a waste bin lid mounted to the waste bin body, and a liner access opening between the waste bin lid and a waste bin base of the waste bin body. The waste bin base includes a litter liner recess to receive a litter liner projection from a litter liner and to align the litter liner with a litter lid opening of the waste bin lid. The waste bin base also includes a recyclables liner recess to receive a recyclables liner projection from the recyclables liner and to align the recyclables liner with a recyclables lid opening of the waste bin lid. A method of recycling is also disclosed in which the waste bins are deployed at facilities and at least a portion of the costs associated with the waste bins are paid by financial sponsors.

### BACKGROUND

Many facilities such as, for example, parks, schools, stadiums, golf courses, municipalities, theaters, and shopping malls place waste bins at numerous locations to encourage patrons of the facility to properly dispose of their waste. However, despite increased public awareness regarding the ecological benefits of recycling, many facilities provide very few if any recycling bins for their patrons. Many facilities cite additional costs associated with purchasing, maintaining, and emptying recycling bins as a justification for providing few, if any, recycling bins to their patrons.

### BRIEF DESCRIPTION OF THE DRAWINGS

Embodiments are described herein by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 shows an embodiment of a waste bin to collect litter and recyclables.

FIG. 2 shows an embodiment of waste bin body of the waste bin of FIG. 1.

FIGS. 3A and 3B show an embodiment of a cover to a liner access opening of the waste bin body of FIG. 2.

FIGS. 4A and 4B show an embodiment of a waste bin lid of the waste bin of FIG. 1.

FIG. 5 shows hinge pins of the cover shown in FIG. 3 and corresponding recesses to receive the hinge pins.

FIGS. 6A and 6B show an embodiment of a litter liner and a recyclables liner of the waste bin of FIG. 1.

FIG. 7 shows an embodiment of a recycling method uses the waste bin of FIG. 1.

### DETAILED DESCRIPTION

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, a particular feature, structure, or characteristic described in connection with an embodiment generally may be incorporated into or otherwise implemented by other embodiments regardless of whether explicitly described.

For ease of discussion, the present description and claims use positional terms such as “upper”, “lower”, “left”, “right”, “top”, “bottom”, “front”, and “back” to refer to various aspects of the disclosed waste bin. Such positional terms were chosen from the perspective of an observer standing in front of the door of the waste bin. One skilled in the art should appreciate that such positional terms are merely presented for ease of discussion and are not intended to limit the waste bin or the scope of the appended claims.

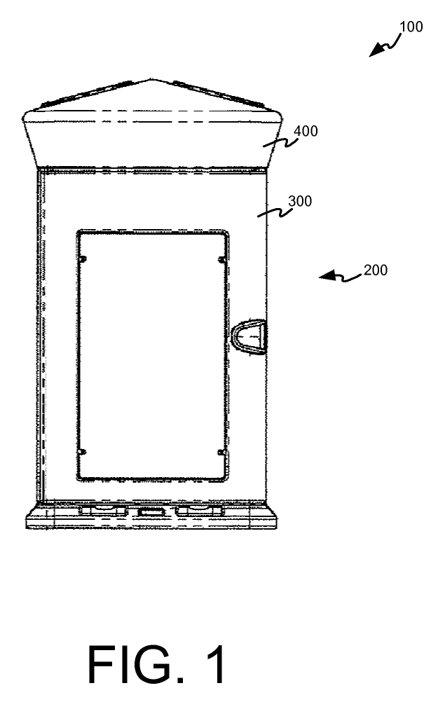

FIG. 1 shows a front view of a waste bin 100 to collect litter and recyclables. As shown, the waste bin 100 may include a waste bin body 200, a cover 300, and a waste bin lid 400.

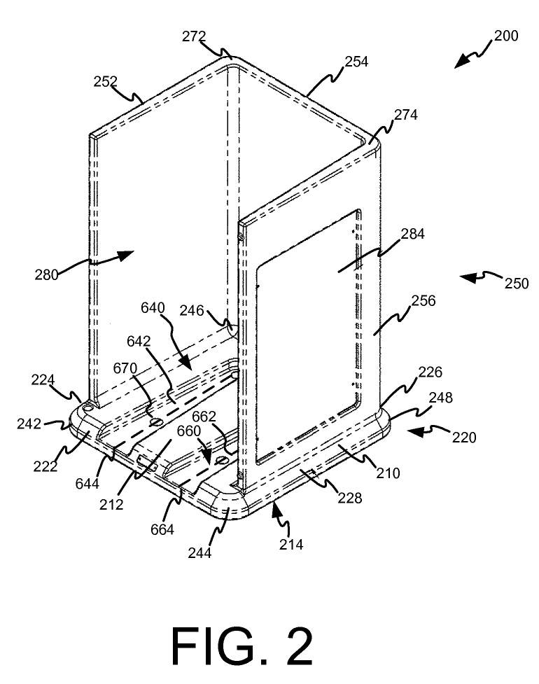

As shown in FIG. 2, the waste bin body 200 may include a waste bin base 210 and one or more waste bin walls 250. As shown, the waste bin base 210 may include an upper surface 212, a lower surface 214, and one or more faces 220 that join the upper surface 212 to the lower surface 214. In particular, the waste bin base 210 may include a front face 222, a left face 224, a back face 226, and a right face 228. Each of the one or more faces 220 may have substantially the same height, length, and width. The front face 222 may be joined to the left face 224 at roughly a 90 degree angle to form a rounded front left corner 242 of the waste bin base 210 and may be joined to the right face 228 at roughly a 90 degree angle to form a rounded front right corner 244. The back face 226 may be joined to the left face 224 at roughly a 90 degree angle to form a rounded back left corner 246 and may be joined to the right face 228 at roughly a 90 degree angle to from a rounded back right corner 248. Accordingly, the waste bin base 210 may have a squarish, horizontal cross section.

The one or more waste bin walls 250 may comprise a left waste bin wall 252, a back waste bin wall 254, and a right waste bin wall 256 that each extend perpendicularly upward from the waste bin base 210 to form three sides of the waste bin body 200. The left waste bin wall 252, the back waste bin wall 254, and the right waste bin wall 256 may each comprise a substantially planar, quadrangular panel having substantially the same height, width, and thickness. The left waste bin wall 252 may be joined to the back waste bin wall 254 at roughly a 90 degree to form a rounded back left corner 272 of the waste bin body 200. Similarly, the right waste bin wall 256 may be joined to the back waste bin wall 254 at roughly a 90 degree angle to form a rounded back right corner 274 of the waste bin body 200. Accordingly, the waste bin walls 250 may define a waste bin body 200 having a generally cuboidal outer shape with a squarish, horizontal cross section. However, the waste bin body 200 in other embodiments may have a different number of waste bin walls 250, may have waste bin walls 250 of unequal dimensions, may have non-planar waste bin walls 250, may have waste bin walls 250 that are not generally quadrangular in shape, and/or may have waste bin walls 250 that are not generally perpendicular to the waste bin base 210.

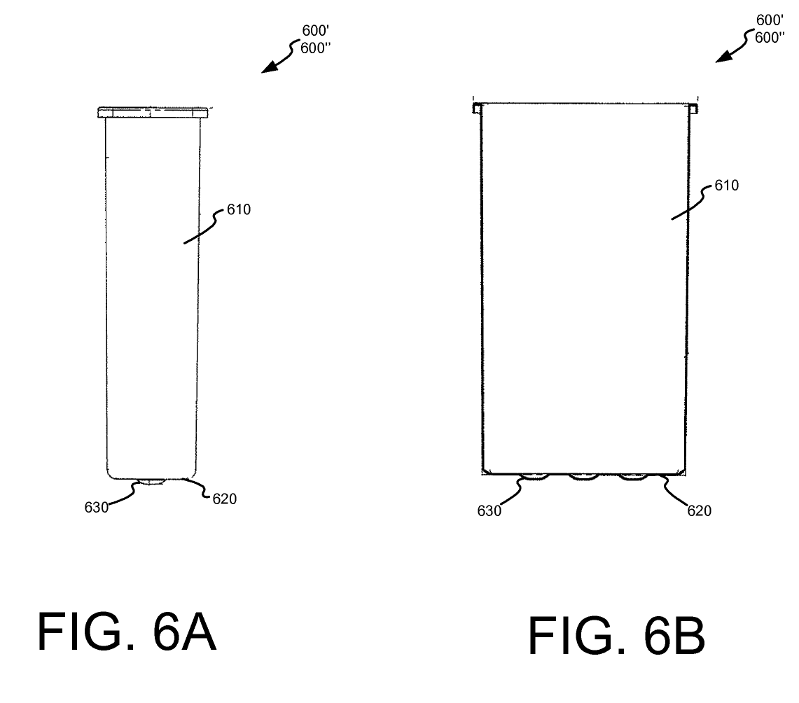

The waste bin walls 250 beside defining sides of the waste bin 100 also define a liner access opening 280 between the waste bin lid 300 and waste bin base 210. The liner access opening 280 is sized to permit insertion and removal of a litter liner 600′ and a recyclables liner 600″ into and from the waste bin body 200 while the waste bin lid 300 is mounted to the waste bin body 200. See, FIGS. 6A and 6B for details regarding the liners 600′, 600″. In one embodiment, the liner access opening 280 is sized to permit the litter liner 600′ and the recyclables liner 600″ to pass simultaneously through the liner access opening 280 in a side by side fashion.

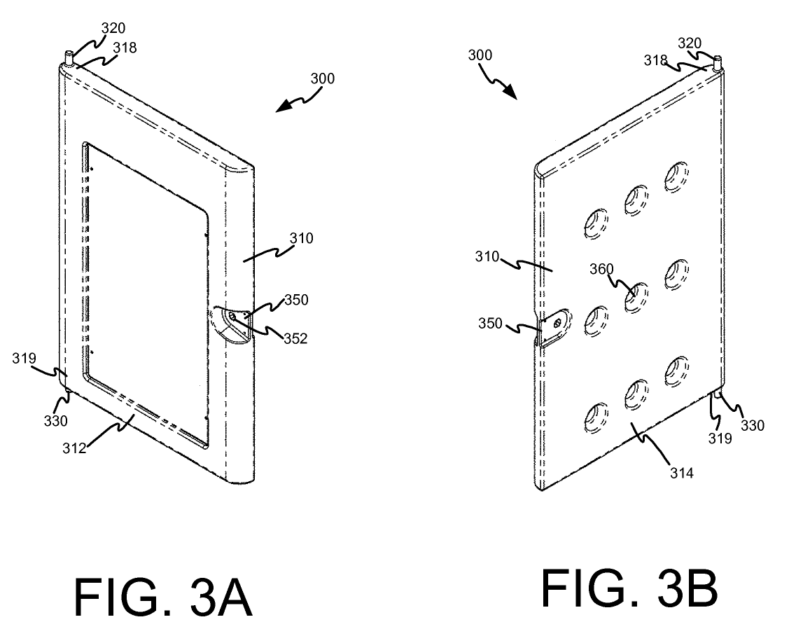

The cover 300 may be positioned to at least partially cover the liner access opening 280 in order to prevent removal of the litter liner 600′ and the recyclables liner 600″ from the waste bin body 200. The cover 300 may also be positioned such that the cover 300 permits removal of the litter liner 600′ and the recyclables liner 600″ from the waste bin body 200. As shown in FIGS. 3A and 3B, the cover 300 may comprises a door 310 having a substantially planar, quadrangular front surface 312 joined to substantially planar, quadrangular back surface 314. The door 310 may have a height, width, and thickness that are substantially similar to the height, width, and thickness of the waste bin walls 250.

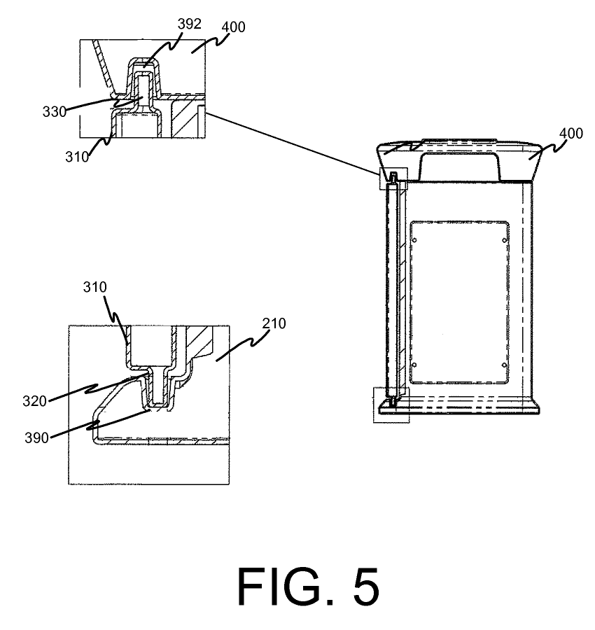

The door 310 may further include an upper hinge pin 320 positioned proximate an upper, left corner 318 of the door 310 and lower hinge pin 330 positioned proximate a lower, left corner 319 of the door 310. As shown in FIGS. 2 and 5, the waste bin base 210 may include a lower hinge pin recess 390 proximate the left front corner 242 to receive the lower hinge pin 320 of the door 310. Similarly, as shown in FIG. 5, the waste bin lid 400 may include an upper hinge pin recess 392 positioned in a front left corner 420 of the waste bin lid 400 to receive the upper hinge pin 330 of the door 210 when the waste bin lid 400 is mounted to the waste bin body 200. The hinge pins 320, 330 and respective hinge pin recesses 390, 392 permit the door 310 to swing away from the waste bin body 200 to an opened position and toward the waste bin body 200 to a closed position. While in the opened position, the door 310 permits insertion and removal of the liners 600′, 600″ via the liner access opening 280. While in the closed position, the door 310 prevents or otherwise blocks insertion and removal of the liners 600′, 600″ via the liner access opening 280.

The door 310 may include a latch 350 to latch the door 310 to the right waste bin wall 256 in a closed position. Moreover, the latch 350 may include a lock 352 to secure the door 310 in the closed position and to prevent unauthorized removal of the liners 600′, 600″ via the liner access opening 280 when locked. The door 310 may further include a plurality of cups 360 in the back surface 314 of the door 310 which add strength to the door 310.

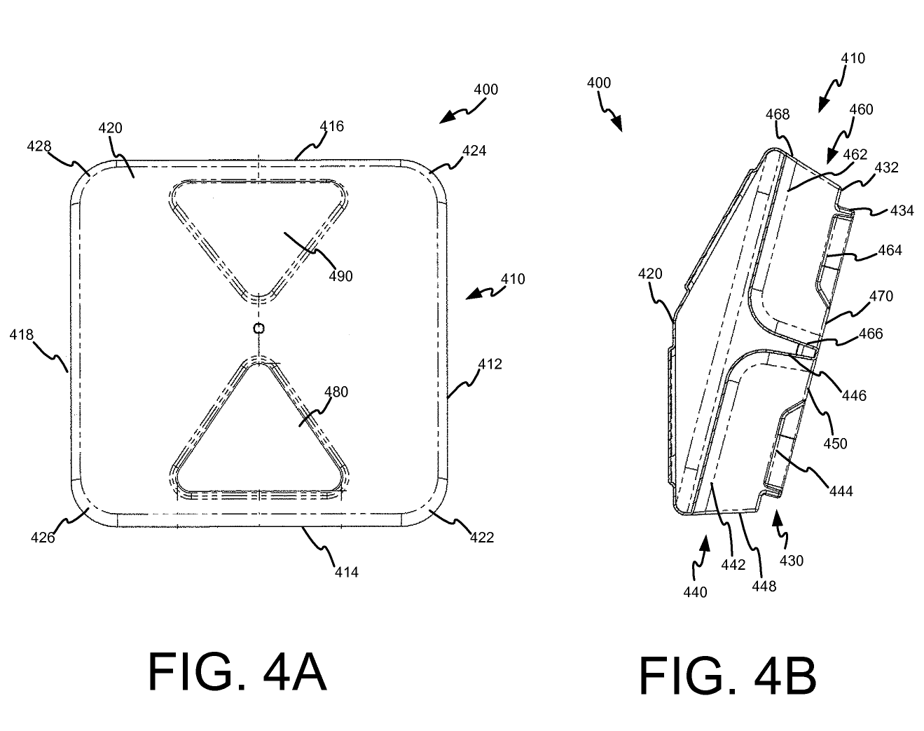

Referring now to FIGS. 4A and 4B, the waste bin lid 400 may include a plurality of faces 410, a top 420, and a male connector 430. The faces 410 may include a front face 412, a left face 414, a right face 416, and a back face 418. The front face 412 may be joined to the left face 414 at roughly a 90 degree angle to form a front left corner 422 and may be joined to the right face 416 at roughly a 90 degree angle to form a front right corner 424. The back face 418 may be joined to the left face 414 at roughly a 90 degree angle to form a back left corner 426 and may be joined to the right face 416 at roughly a 90 degree angle to form a back right corner 428. In one embodiment, each of the face 412 have a similarly sized, quadrangular shape thus resulting in the waste bin lid 400 having a squarish, horizontal cross section.

The male connector 430 comprises a ledge 432 and walls 434. The waste bin lid 400 may be mounted to the waste bin body 200 such that the ledge 432 rests upon an upper end 202 of the waste bin walls 250 that is distal from the waste bin base 210. Further, the waste bin walls 250 may receive and/or otherwise engage the male connector walls 434 to prevent lateral movement of the waste bin lid 400 mounted to the waste bin walls 250. In one embodiment, the waste bin lid 400 may include one of more mounting holes (not shown) in the ledge 432 through which fasteners (e.g. screws, rivets, etc.) may affix the waste bin lid 400 to the waste bin walls 250 and may prevent removal of the waste bin lid 400 from the waste bin body 200.

The waste bin lid 400 further includes a litter chute 440 to deliver litter to the litter liner 600′, and a recyclables chute 460 to deliver recyclables to the recyclables liner 600″. As shown, the litter chute 440 may include an upper wall 442, a lower wall 444, and a central wall 446 which connect a litter lid opening 448 in the left face 414 of the waste bin lid 400 to a litter drop opening 450 positioned over the litter liner 600′. Thus, litter placed in the litter lid opening 448 is delivered to the litter liner 600′ via the litter chute 440 and litter drop opening 450. Similarly, the recyclables chute 460 may include an upper wall 462, a lower wall 464, and a central wall 466 which connect a recyclables lid opening 468 in a right face 416 of the waste bin lid 400 to a litter drop opening 470 positioned over the recyclables liner 600″. Thus, recyclables placed in the recyclables lid opening 468 are delivered to the recyclables liner 600″ via the recyclables chute 460 and recyclables drop opening 470. Besides delivering litter and recyclables to respective liners 600′, 600″, the chutes 440, 460 may help prevent people from removing litter and especially recyclables from the waste bin 100 via the openings 448, 468. Furthermore, the lower walls 442, 462 of the chutes 440, 460 may help prevent litter and/or recyclables from falling out of the waste bin 100 in the event the waste bin 100 is tipped over.

The waste bin lid 400 may also include, on the waste bin top 430, litter indicia 480 associated with the litter lid opening 448 and recyclables indicia 490 associated with the recyclables opening 468. The litter indicia 480 may include an imprint, decal, or other markings that indicate litter is to be deposited in the waste bin 100 via the litter lid opening 448. Similarly, the recyclables indicia 490 may include an imprint, decal or other marking that indicates recyclables are to be deposited in the waste bin 100 via the recyclables lid opening 468.

As shown in FIG. 6, each liner 600′, 600″ may comprise liner walls 610, a liner base 620, and liner projections 630. The liner walls 610 and liner base 620 may define a cavity into which litter or recyclables may be collected. The liner projections 630 may extend beyond the liner base 620. In one embodiment, the liner projections 630 may include several in-line bumps 632. Besides providing a guide for the liners 600′, 600″ during insertion and removal of the liners 600′, 600″, the projections 630 also provide a theft deterrent since the projections 630 prevent freestanding of the liners 600′, 600″.

Referring back to FIG. 2, the waste bin base 210 includes at least one litter liner recess 640 and at least one recyclables recess 660 in an upper surface 212 of the waste bin base 210 to receive liner projections 630 from respective liners 600′, 600″. The liner projections 630 and corresponding recesses 640, 660 are arranged such that the projections 630 are received by the recesses 640, 660 when the liners 600′, 600″ are inserted into the waste bin body 200 via the liner access opening 280.

In one embodiment, each liner recess 640, 660 comprises an elongated track 642, 662 to receive liner projections 610. The elongated tracks 642, 662 help guide the liners 600′, 600″ into position under the drop openings 450, 470 as the liners 600′, 600″ are received via the liner access opening 280. In one embodiment, the elongated litter liner track 642 and the elongated recyclables liner track 662 are positioned such that a center line 644 of the elongated litter liner track 642 runs substantially parallel with a center line 664 of the elongated recyclables liner track 662 and the center line 644 of the elongated litter liner track 642 runs substantially perpendicular to the liner access opening 280. Moreover, to ease insertion and removal of the liners 600′, 600″, the liner recesses 640, 660 extend through the front face 222 of the waste bin base 210, proximate the liner access opening 280. Accordingly, the liner projection 630 are permitted to pass through the front face 222 as the liners 600′, 600″ are inserted into or removed from the waste bin body 200 via the liner access opening 280. Furthermore, each liner recess 640, 660 in one embodiment has a width 644, 664 that generally tapers from a broader width proximate the liner access opening 280 to a narrower width distal from the liner access opening 280.

The liners 600′, 600″ and the waste bin body 110 may be arranged such that a collection worker is unable to insert both the litter liner 600′ and the recyclables liner 600″ into the waste bin body 110 if the liners 600′, 600″ are not aligned with their respective drop openings 450, 470 in the waste bin lid 400. In particular, the liner projections 630 may extend sufficiently beyond a bottom liner surface 620 to prevent insertion of both the liner 600′, 600″ into the waste bin body 200 if the litter liner projection 630 and the recyclables liner projection 630 rests upon the upper surface 212 of the waste bin base 210 instead of in their respective liner recesses 640, 660 in the waste bin base 210.

Thus, if a collection worker does not place the litter liner projection 630 and the recyclables liner projection 630 respectively into the litter liner recess 640 and the recyclables liner recess 660 in the upper surface 212 of the waste bin base 210, then a collection worker may be unable to insert the liners 600′, 600″ into the waste bin body 200 through the liner access opening 280. In particular, as the liners 600′, 600″ are inserted into the waste bin body 200, the elongated tracks 642, 662 engage the liner projections 630 and urge the liners 600′, 600″ into proper position under the litter drop opening 450 and the recyclables drop opening 470. Similarly, the elongated tracks 642, 664 may help guide the liners 600′, 600″ during removal. In particular, the elongated tracks 642, 662 may help maintain the liners 600′, 600″ aligned with the liner access opening 280 during removal. Accordingly, the liner recesses 642, 662 may make a collection workers job easier as the tracks 642, 662 ensure proper alignment of the liners 600′, 600″ during insertion of the liners 600′, 600″ into the waste bin body 200 and during removal of the liners 600′, 600″ from the waste bin body 200.

As shown in FIG. 2, the recesses 640, 660 may further comprise anchor holes 670 that pass through the waste bin base 210. The anchor holes 670 may receive anchors or other fasteners that affix the waste bin base to earth, concrete or other material upon which the waste bin 100 may be placed at a facility. The use of such anchors may help to prevent the waste bin 100 from tipping over due to inclement weather, vandals, unbalanced loading, or other causes. Moreover, the use of anchors may also help deter theft of the waste bin 100.

As mentioned above, the waste bin body 200, the waste bin base 210 and the waste bin lid 400 may each have a squarish, horizontal cross section. The squarish, horizontal cross sections of the waste bin body 200, waste bin base 210 and waste bin lid 400 may result in a waste bin 100 having a generally cuboidal outer shape that is non-conducive to rolling regardless of whether standing upon its base 210 or lying upon a side. However, while the waste bin 100 has been described as having a generally cuboidal outer shape, the waste bin body 200, waste bin base 210 and/or waste bin lid 400 may be constructed to have a different geometric cross section that results in a waste bin having a non-cuboidal outer shape that is still non-conducive to rolling.

Moreover, in one embodiment, the waste bin base 210, the waste bin walls 250, and cover 300 may each include an advertisement recess 284 upon an outer surface. The advertisement recesses 284 provide locations to which decals, posters, and/or other advertisement materials may be affixed to the waste bin 100. Thus, rights to place advertisements upon the waste bin 100 may be sold or leased to various organizations in order to raise revenue.

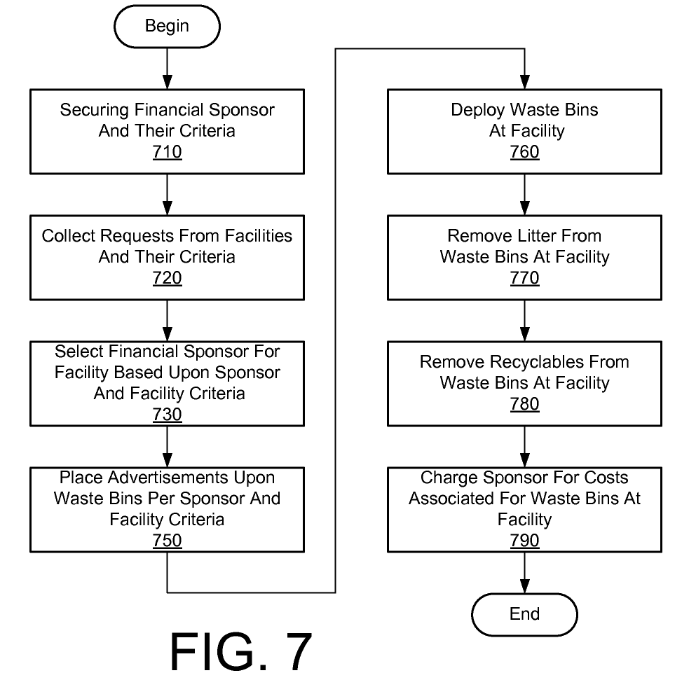

Referring now to FIG. 7, an embodiment of a recycling method that uses the waste bin 100 is shown. The method begins at block 710 with a program facilitator securing several financial sponsors. In particular, the program facilitator obtains agreements from financial sponsor that obligate each financial sponsor to pay for at least a portion of costs associated with deploying the waste bins 100 at a facility. In exchange, for the financial commitment, the program facilitator places or permits placement of advertisements selected by the financial sponsor upon the advertisement recesses 284 of the waste bins 100. Such agreements may specify facilities at which the financial sponsor would like to advertise, the amount the financial sponsor is committing toward the program, the nature of the advertisements the financial sponsor wishes to place on the waste bins 100, the duration of the sponsorship, number of facilities to sponsor, etc.

The method further includes the program facilitator at block 720 collecting requests from several facilities that desire to deploy the waste bins 100 at their facilities. Such requests may indicate a number of waste bins 100 that are desired to be deployed as well as any preferences regarding types of advertisements to be placed upon the waste bins 100. Such preferences may be of a general form (e.g. advertisements suitable for all ages) or more specific in nature (e.g. no religious, political, or adult oriented advertisements).

At block 730, the program facilitator selects a financial sponsor for a facility. In particular, the financial sponsor is selected from the plurality of secured financial sponsors based upon criteria specified by the financial sponsor and the facilitates. Ideally, a financial sponsor is paired with a facility in a manner that creates a synergistic relationship between the facility and the financial sponsor. Namely, the advertisements are not only unobjectionable to the facility but of interest to the persons that frequent the facility.

After selecting the financial sponsor for a facility, the program facilitator at block 750 places or permits placement of advertisements upon the waste bins 100 per criteria of the selected financial sponsor and the facility. Such advertisements may be created or otherwise supplied by the financial sponsor. In other embodiments, the program facilitator may create advertisements per criteria specified by the financial sponsor and/or facility to receive the waste bins 100. The program facilitator at block 760 then deploys the waste bins 100 with the advertisements to the facility.

At 770, litter is periodically removed from each waste bin 100 deployed to the facility by removing a litter liner 600′ from each waste bin 100 via a door 310 of each waste bin 100, Similarly, recyclables at block 780 are periodically removed from each waste bin 100 deployed to the facility by removing a recyclable liner 600″ from each waste bin 100 via the door 310 of each waste bin 100. In one embodiment, the program facilitator removes or arranges for other parties to remove the litter and recyclables from the waste bins 100. In other embodiments, the facility removes and/or arranges for other parties to remove the litter and recycles from the waste bins 100.

At block 790, the financial sponsor is charged for costs associated with periodically removing recyclables from each waste bin 100 deployed to the facility. In one embodiment, the program facilitator invoices the financial sponsor for such costs as they occur. In other embodiments, the financial sponsor pays for such costs upfront or in installments over the course of the agreement. In yet other embodiments, the facility invoices the financial sponsor for such costs. In yet another embodiment, the parties that remove the litter and/or recyclables invoice the financial sponsor for such costs. It should be appreciated that costs associated with the waste bins 100 that are charged to the financial sponsors may include costs associated with deploying the waste bins 100 to the facility, costs associated with collecting the litter and recyclables from the waste bins 100, costs associated with transferring collected recyclables to a recycling facility, costs associated with manufacturing and/or acquiring the waste bins 100, costs associated with creating and/or placing advertisements on the waste bins; and/or overhead costs of the program facilitator associated with executing the recycling method.

Many modifications and variations of the disclosed embodiments are possible in light of the above teachings. Thus, it is to be understood that, within the scope of the appended claims, aspects of the disclosed embodiments may be practiced in a manner other than as described above.

What is claimed is:

1. A waste bin to collect litter and recyclables, comprising
an waste bin body to house a litter liner to collect litter and a recyclables liner to collect recyclables, the waste bin body comprising an waste bin base and one or more waste bin walls;
a waste bin lid on an upper end of the waste bin body that is distal from the waste bin base, the waste bin lid comprising a litter lid opening and associated litter indicia that indicates litter is to be deposited via the litter lid opening, and a recyclables lid opening and associated recyclable indicia that indicates recyclables are to be deposited via the recyclables lid opening;
a liner access opening between the waste bin lid and the waste bin base to permit insertion and removal of the litter liner and the recyclables liner into and from the waste bin body;
a cover positioned over the liner access opening of the waste bin body;
at least one litter liner recess in an upper surface of the waste bin base to receive a litter liner projection from the litter liner and to align the litter liner with the litter lid opening as the litter liner is received by the waste bin body via the liner access opening; and
at least one recyclables liner recess in the upper surface of the waste bin base to receive a recyclables liner projection from the recyclables liner and to align the recyclables liner with the recyclables lid opening as the recyclable liner is received by the waste bin body via the liner accessing opening.

2. The waste bin of claim 1, further comprising
the litter liner inserted into the waste bin body with the litter liner projection extending into the litter liner recess and aligned with the litter lid opening to receive litter, and
the recyclables liner inserted into the waste bin body with the recyclables liner projection extending into the recyclables liner recess and aligned with the recyclables lid opening to receive recyclables.

3. The waste bin of claim 1, further comprising the litter liner and the recyclables liner, wherein the litter liner projection extends sufficiently beyond a bottom litter liner surface of the litter liner and the recyclables liner projection extends sufficiently beyond a bottom recyclables liner surface of the recyclables liner to prevent insertion of both the litter liner and the recyclables liner in the waste bin body with the litter liner projection and the recyclables liner projection upon the upper surface of the waste bin base.

4. The waste bin of claim 1, further comprising the litter liner and the recyclables liner, wherein the litter liner projection extends sufficiently beyond a bottom litter liner surface of the litter liner and the recyclables liner projection extends sufficiently beyond a bottom recyclables liner surface of the recyclables liner to prevent insertion of both the litter liner and the recyclables liner in the waste bin body if the litter liner projection and the recyclables liner projection are not respectively inserted into the litter liner recess and the recyclables liner recess in the upper surface of the waste bin base.

5. The waste bin of claim 1, further comprising the litter liner and the recyclables liner, wherein
the litter liner projection comprising a plurality of bumps that extend sufficiently beyond a bottom litter liner surface of the litter liner and that are arranged in a line to permit linear translation of the plurality of bumps along the litter liner recess as the litter liner is inserted into the waste bin body via the liner access opening, and
the recyclables liner projection comprising a plurality of bumps that extend sufficiently beyond a bottom recyclables liner surface of the recyclables liner and that are arranged in a line to permit linear translation of the plurality of bumps along the recyclables liner recess as the recyclables liner is inserted into the waste bin body via the liner access opening.

6. The waste bin of claim 1, wherein
the litter liner recess in the waste bin base comprises an elongated litter liner track to receive and guide the litter liner via the litter liner projection as the litter liner is inserted into the waste bin body via the liner access opening, and
the recyclables recess in the waste bin base comprises an elongated litter liner track to receive and guide the recyclables liner via the recyclables liner projection as the recyclables liner is inserted into the waste bin body via the liner access opening.

7. The waste bin of claim 1, wherein
the litter liner recess in the waste bin base comprises an elongated litter liner track to receive the litter liner projection,
the recyclables liner recess in the waste bin base comprises an elongated recyclables liner track to receive the recyclables liner projection, and
the elongated litter liner track and the elongated recyclables liner track are positioned such that a center line of the elongated litter liner track runs substantially parallel with a center line of the elongated recyclables liner track and the center line of the elongated litter liner track runs substantially perpendicular to the liner access opening.

8. The waste bin of claim 1, wherein
the litter liner recess in the waste bin base extends to a front face of the waste bin base proximate the liner access to permit the litter liner projection to pass through the front face as the litter liner is removed from the waste bin body via the liner access opening, and
the recyclables liner recess in the waste bin base extends to the front face of the waste bin base to permit the recyclables liner projection to pass through the front face as the recyclables liner is removed from the waste bin body via the liner access opening.

9. The waste bin of claim 1, wherein
the litter liner recess in the waste bin base has a width that generally tapers from a broader width proximate the liner access opening to a narrower width distal from the liner access opening, and
the litter liner recess in the waste bin base has a width that generally tapers from a broader width proximate the liner access opening to a narrower width distal from the liner access opening, and

10. The waste bin of claim 1, wherein the cover comprises a door hinged to swing outwardly from the liner access opening to permit insertion and removal of the litter liner and the recyclables liner into and from the waste bin body.

11. The waste bin of claim 1, further comprising a lock to secure the cover over the liner access opening and prevent removal of the litter liner and the recyclables liner when locked.

12. The waste bin of claim 1, further comprising the litter liner and the recyclables liner, wherein
the litter liner projection extends sufficiently beyond a bottom litter liner surface of the litter liner to prevent freestanding of the litter liner, and
the recyclables liner projection extends sufficiently beyond a bottom recyclables liner surface of the recyclables liner to prevent freestanding of the recyclables liner.

13. The waste bin of claim 1, wherein
the one or more waste bin walls comprise three substantially planar waste bin walls extending upwardly from the waste bin base; and
the cover and the three substantially planar waste bin walls are arranged as vertical sides of a cuboid.

14. The waste bin of claim 1, wherein the waste bin body has an outer shape non-conducive to rolling when the waste bin is tipped over to lie upon a waste bin wall of the one or more waste bin walls.

15. The waste bin of claim 1, wherein an outer surface of waste bin body comprises a substantially planar recess upon which an advertisement is placed.

16. The waste bin of claim 1, wherein the waste bin base comprises a plurality of anchor holes to permit anchoring the waste bin body.

17. A method of collecting recyclables, comprising
securing a plurality of financial sponsors that agree to pay for at least a portion of costs associated with waste bins suitable to collect both litter and recyclables in exchange for advertisements upon the waste bins;
collecting requests from a plurality of facilities desiring to deploy waste bins to collect both letter and recyclables;
selecting a financial sponsor of the plurality of financial sponsors for a facility of the plurality of facilities based upon criteria specified by the plurality of financial sponsors and the plurality of facilities;
placing advertisements upon waste bins per criteria of the selected financial sponsor;
deploying the waste bins with advertisements per the selected financial sponsor to the facility;
periodically removing litter from each waste bin deployed to the facility by removing a litter liner from each waste bin via a door of each waste bin,
periodically removing recyclables from each waste bin deployed to the facility by removing a recyclable liner from each waste bin via the door of each waste bin, and
charging the selected financial sponsor for costs associated with periodically removing recyclables from each waste bin deployed to the facility.

18. The method of claim 17, further comprising charging the selected financial sponsor for costs associated with deploying the waste bins to the facility.

19. The method of claim 17, further comprising charging the selected financial sponsor for costs associated with collecting the litter and recyclables.

20. The method of claim 17, further comprising
transferring collected recyclables to a recycling facility; and
charging the selected financial sponsor for costs associated with transferring the recyclables to the recycling facility.
